(19) United States
(12) Patent Application Publication
(10) Pub. No.: US 2017/0263093 A1
(43) Pub. Date: Sep. 14, 2017

(54) ANTI-THEFT DEVICE

(71) Applicant: USS Technologies, LLC, Rancho Cucamonga, CA (US)

(72) Inventors: Adel O. Sayegh, Rancho Cucamonga, CA (US); Marc Trincale, Rancho Cucamonga, CA (US); Michael Sayegh, Rancho Cucamonga, CA (US)

(21) Appl. No.: 15/068,621

(22) Filed: Mar. 13, 2016

(51) Int. Cl. G08B 13/24; B65D 25/20

(52) U.S. Cl. CPC G08B 13/2434; B65D 25/20

(57) ABSTRACT

The present invention discloses an anti-theft device comprised of a member that mounts onto and encompasses an article via a securing structure of the member, with the member including an Electronic Article Surveillance (EAS) device.

### CROSS-REFERENCE TO RELATED APPLICATIONS

This application claims the benefit of priority of co-pending U.S. Utility Provisional Patent Application 62/133,147, filed Mar. 13, 2015 the entire disclosure of which is expressly incorporated by reference in its entirety herein.

It should be noted that throughout the disclosure, where a definition or use of a term in any incorporated document(s) is inconsistent or contrary to the definition of that term provided herein, the definition of that term provided herein applies and the definition of that term in the incorporated document(s) does not apply.

### BACKGROUND OF THE INVENTION

Field of the Invention

One or more embodiments of the present invention relate to an anti-theft device and, more particularly, to an anti-theft device for deterring theft of containers, non-limiting examples of which may include cans or canned products.

Description of Related Art

Conventional anti-theft devices for protecting articles are well known and have been in use for a number of years. Regrettably, most known anti-theft devices for protecting articles such as containers are comprised of locking boxes or Electronic Article Surveillance (EAS) boxes or vaults that house the article within, which means that the anti-theft device itself is a container.

Container type EAS boxes or vaults that securely house an article are bulky, taking large amount of shelf-space for display or storage of the protected article. Additionally, the EAS boxes or vaults prevent consumers from accessing the article housed within the EAS box or vault. That is, since the article is housed within the EAS box for example, consumers would have difficulty accessing the article to read for example article labels such as expiration date, ingredients (if the article is a canned food item), etc.

Accordingly, in light of the current state of the art and the drawbacks to current anti-theft devices mentioned above, a need exists for an anti-theft device that would provide protection for an article such as a container that is not bulky, and enables access to the article by consumers while the article is protected by the anti-theft device.

### BRIEF SUMMARY OF THE INVENTION

A non-limiting, exemplary aspect of an embodiment of the present invention provides an anti-theft device, comprising:

a member with a first free end and a second free end;

the first free end having a first securing structure;

the second free end having a second securing structure; and

an Electronic Article Surveillance (EAS) device that is associated with the member.

Another non-limiting, exemplary aspect of an embodiment of the present invention provides a theft-deterrent device, comprising:

a annular member with a first free end and a second free end;

the first free end having a first securing structure;

the second free end having a second securing structure;

first free end and the second free end interlock through first securing structure and second securing structure by an interlock mechanism; and

an Electronic Article Surveillance (EAS) device that is associated with the annular member.

Still another non-limiting, exemplary aspect of an embodiment of the present invention provides a theft-deterrent device, comprising:

a member comprised of a first piece with a first free end and a second piece with a second free end;

the first free end having a first securing structure;

the second free end having a second securing structure;

first free end and the second free end interlock through first securing structure and second securing structure by an interlock mechanism; and

an Electronic Article Surveillance (EAS) device that is associated with at least one of the first or second piece.

These and other features and aspects of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIG. 1 is a non-limiting, exemplary illustration of an anti-theft device attached to an article in accordance with one or more embodiments of the present invention;

FIG. 2A is a non-limiting, exemplary illustration of an anti-theft device that is exemplarily illustrated in FIG. 1 in a closed (clasped) position and without the attached article in accordance with one or more embodiments of the present invention, with FIG. 2B illustrating the same but in an open (unlocked) position in accordance with one or more embodiments of the present invention; and FIG. 2C is a non-limiting, exemplary illustration of FIG. 2B, but with interlocking mechanism detached in accordance with one or more embodiments of the present invention;

FIGS. 3A to 3G are non-limiting, exemplary illustrations of various views of the first and the second pieces of the member of the anti-theft device exemplarily illustrated in FIGS. 1 to 2C in accordance with one or more embodiments of the present invention;

FIGS. 4A to 4H are non-limiting, exemplary illustrations of an exemplary interlocking mechanism in accordance with one or more embodiments of the present invention;

FIGS. 5A to 5C are non-limiting, exemplary illustrations of another embodiment of an anti-theft device in accordance with one or more embodiments of the present invention; and

FIGS. 6A to 6D are non-limiting, exemplary illustrations of yet another embodiment of an anti-theft device in accordance with one or more embodiments of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

It is to be appreciated that certain features of the invention, which are, for clarity, described in the context of separate embodiments, may also be provided in combination in a single embodiment. Conversely, various features of the invention that are, for brevity, described in the context of a single embodiment may also be provided separately or in any suitable sub-combination or as suitable in any other described embodiment of the invention. Stated otherwise, although the invention is described below in terms of various exemplary embodiments and implementations, it should be understood that the various features and aspects described in one or more of the individual embodiments are not limited in their applicability to the particular embodiment with which they are described, but instead can be applied, alone or in various combinations, to one or more of the other embodiments of the invention.

One or more embodiments of the present invention include an anti-theft device that is not bulky and that provides protection for an article such as a container. Further, one or more embodiments of the present invention include an anti-theft device that enables access to the article by consumers while the article is protected by the anti-theft device. In other words, while the article is being protected, the article may physically be handled by consumers for a variety of reasons such as checking if the article is tampered or reading label information (e.g., expiration date, ingredients, etc.).

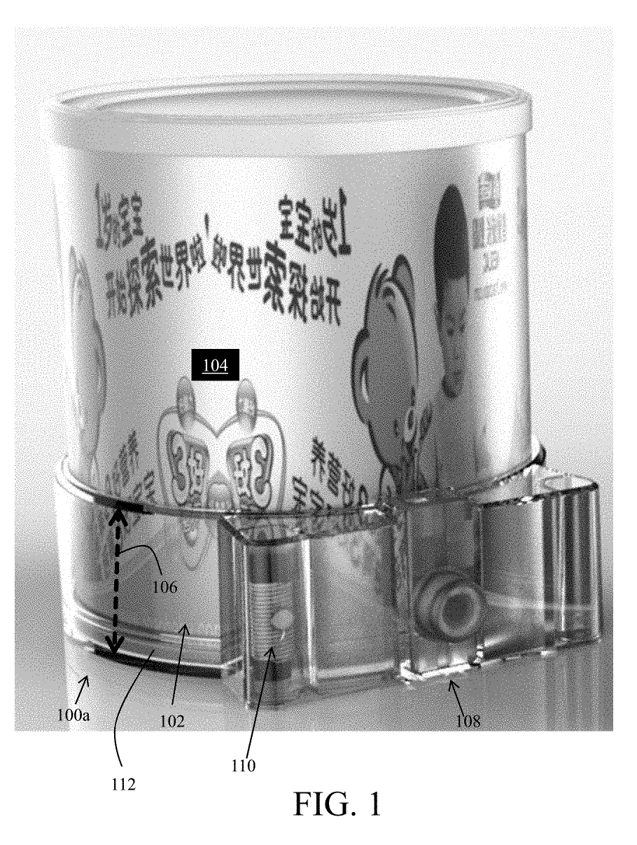

FIG. 1 is a non-limiting, exemplary illustration of an anti-theft device attached to an article in accordance with one or more embodiments of the present invention. As illustrated, anti-theft device 100a is comprised of a member 102 that is transparent and generally rigid, which encloses to contain and protect article 104. Although member 102 is exemplarily illustrated as annular (e.g., generally in a form of a locking “ring”) that surrounds or encompasses article 104, other configurations are also possible such as a polygonal locking clasps rather than circular. Member 102 has a small form with a short height 106, enabling consumers to directly handle article 104, with all label information on article 104 clearly visible to all consumers, including portions covered by transparent member 102. Accordingly, since anti-theft device 100a is small and transparent, it takes small amount of shelf-space for display or storage of the protected article 104, while providing consumers direct access to article 104 with all labeling visible (e.g., expiration date, ingredients (if the article is a canned food item), etc.).

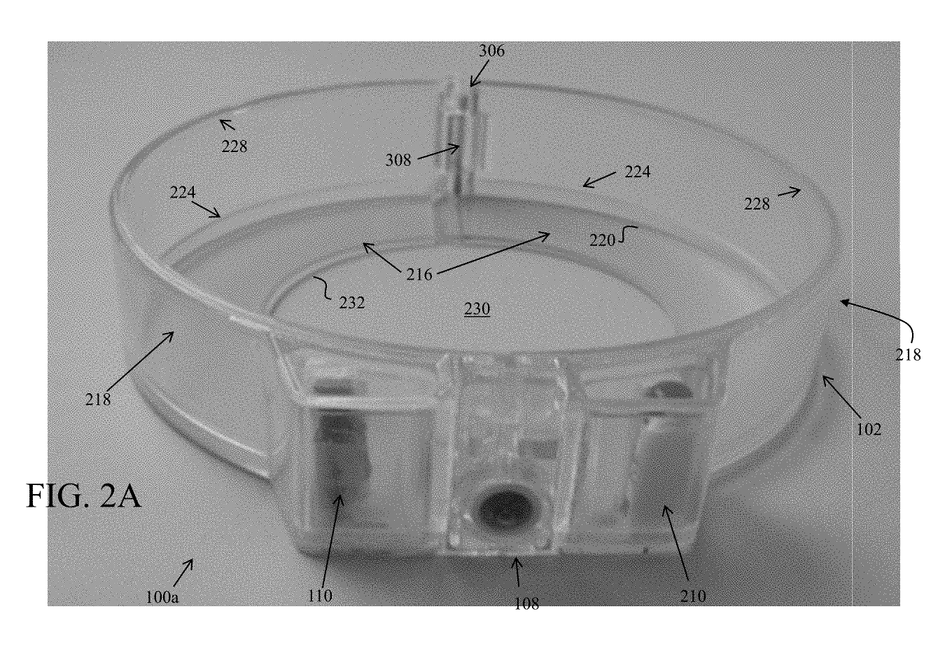

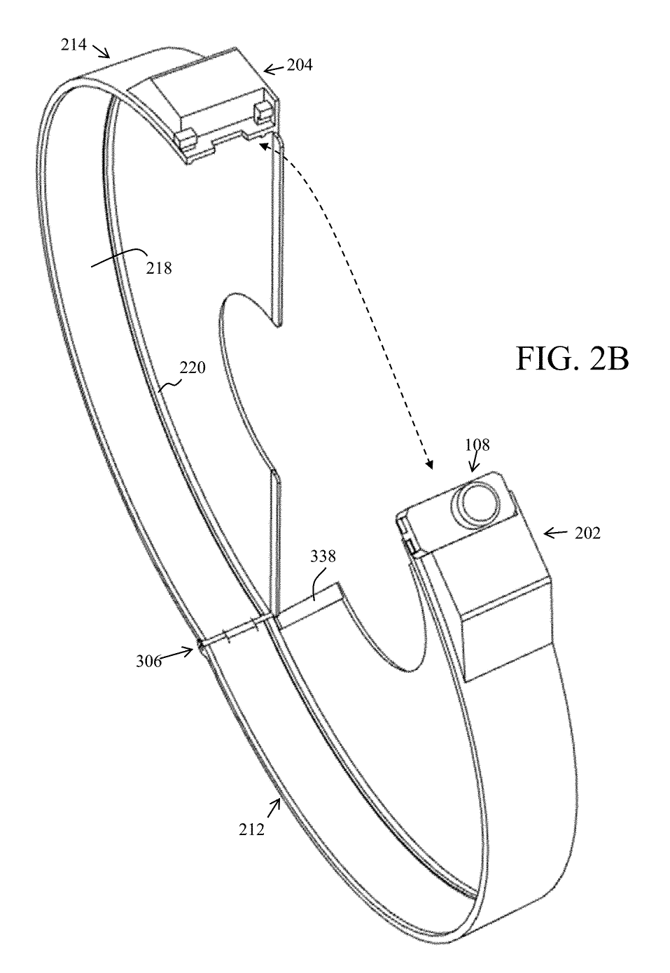

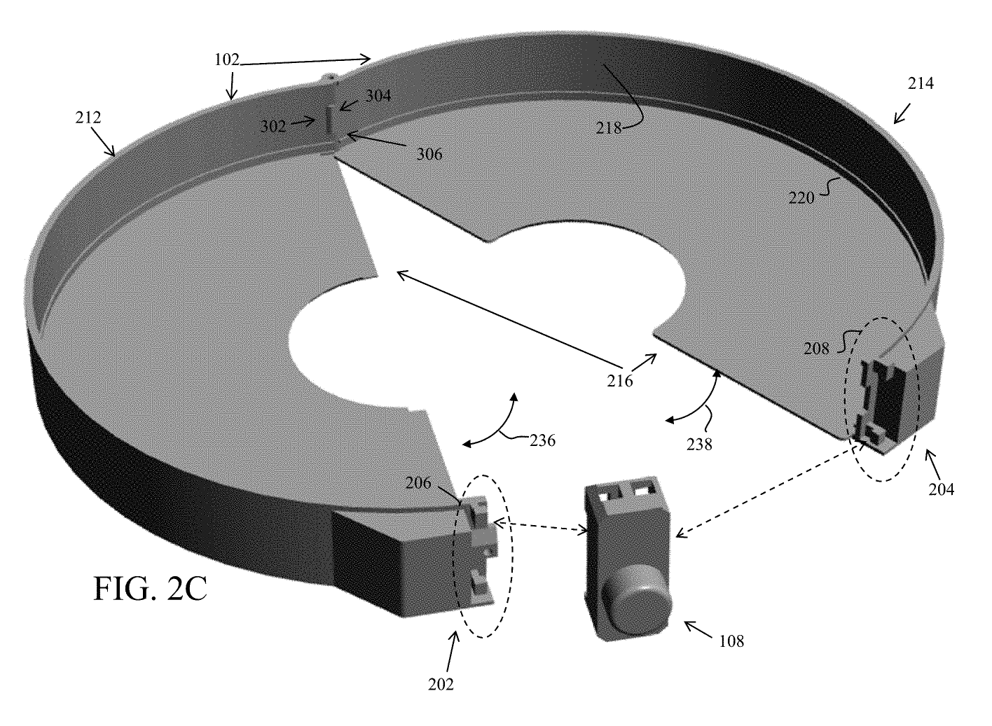

FIG. 2A is a non-limiting, exemplary illustration of an anti-theft device that is exemplarily illustrated in FIG. 1 in a closed (clasped) position and without the attached article in accordance with one or more embodiments of the present invention, with FIG. 2B illustrating the same but in an open (unlocked) position in accordance with one or more embodiments of the present invention. FIG. 2C is a non-limiting, exemplary illustration of FIG. 2B, but with interlocking mechanism detached in accordance with one or more embodiments of the present invention.

As illustrated in FIGS. 1 to 2C, anti-theft device 100a is comprised of member 102 with a first free end 202 and a second free end 204. First free end 202 has a first securing structure 206, and second free end 204 has a second securing structure 208. Further included (and best illustrated in FIGS. 1 and 2A), are one or more Electronic Article Surveillance (EAS) devices 110 and 210 that are associated with member 102. As illustrated in FIGS. 1 to 2C, member 102 is adapted to engage with article 104 by clasping to article 104.

EAS devices 110 and 210 (best shown in FIG. 2A) may comprise of marker circuits (which are well known) that may respond to specific types of electronic surveillance signals of different types of well known EAS systems, non-limiting examples of which may include Magnetic, Acousto-Magnetic (AM), Radio Frequency (RF), Microwave, etc. For example, EAS devices 110 and 210 may comprise a ferrite coil antenna that includes an inductor L and capacitor C (e.g., an LC tank) for radio frequency (RF) systems, amorphous metals for Magnetic systems, magnetostrictive and or ferromagnetic amorphous metals for use with acousto-magnetic (AM) systems, or non-linear elements such as a diode for Microwave systems. It should be noted that several marker EAS devices of different types may be used within the same anti-theft device 100a, with each tuned (or adapted) to a different resonant frequency and or system for activation of different types of EAS systems. Accordingly, EAS devices 110 and 210 need not be identical. A non-limiting example of a resonant marker circuit (with passive LC tank) is detailed in U.S. Pat. No. 7,336,180 to Sayegh et al., the entire disclosure of which is incorporated by reference herein in its entirety.

Referring back to FIGS. 1 to 2C and as further detailed below, first securing structure 206 and second securing structure 208 form complementary interlocking securing structures that may be interlocked by a detachable interlocking mechanism 108, which may be unlocked by an unlocking mechanism (such as a well known magnetic detacher). Member 102 includes a base 216 and a wall 218 that generally vertically extends from an outer periphery 220 of base 216. Base 216 has a surface area with sufficient expanse that engages with and supports a portion of article 104. Further, in this non-limiting, exemplary embodiment, base 216 has an opening 230 defined by an inner periphery 232 of base 216.

Wall 218 includes a first engagement structure 224 near base 216, and a second engagement structure 228 generally at or near top of wall 218. In this non-limiting, exemplary instance, first engagement structure 224 may comprise of an interior facing side recess (e.g., a formed groove, channel, etc.) for receiving a projection 112 from article 104 to thereby securely interlock article 104 with member 102. Further, in this non-limiting, exemplary instance second engagement structure 228 may comprise of an interior facing protuberance that engages projection 112 from article 104 when article 104 is forcibly moved out of first engagement structure 224. Stated otherwise, first and second engagement structures 224 and 228 prevent sliding article 104 out from the clasp of member 102 and detachment of member 102 from of article 104. As best illustrated in FIG. 2C, in this non-limiting, exemplary instance, member 102 is comprised of a first piece 212 that is movably associated with a second piece 214 (along reciprocating paths indicated by arrows 236 and 238).

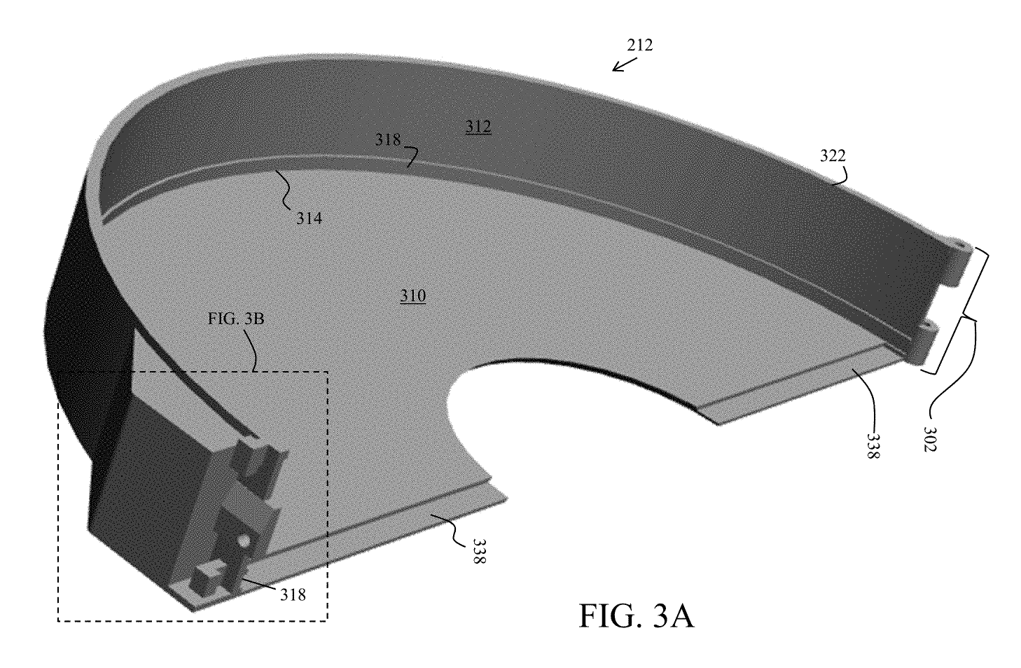

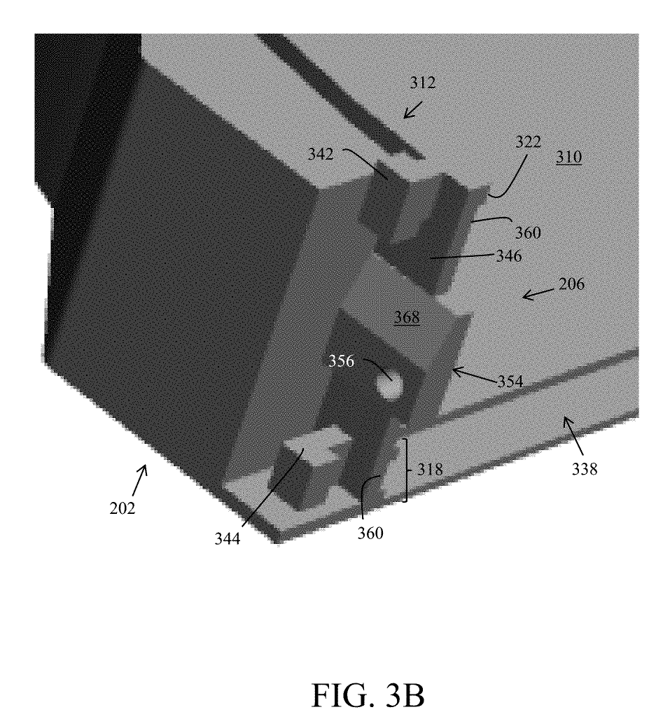

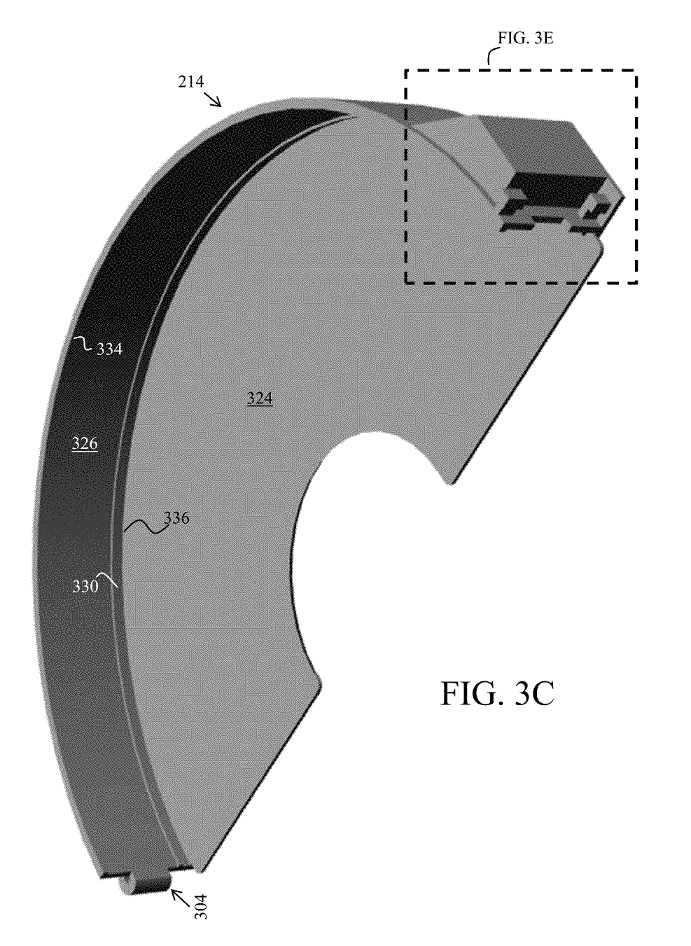

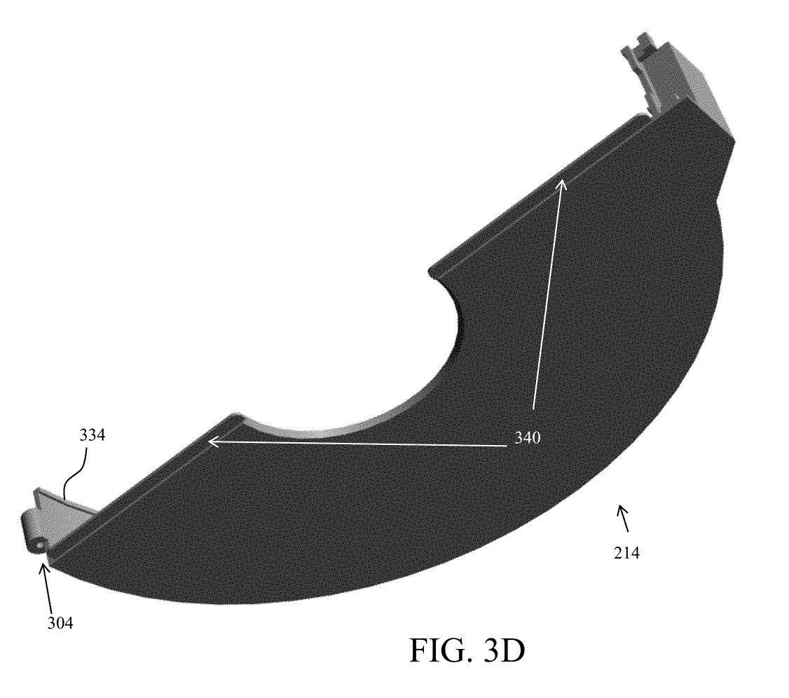

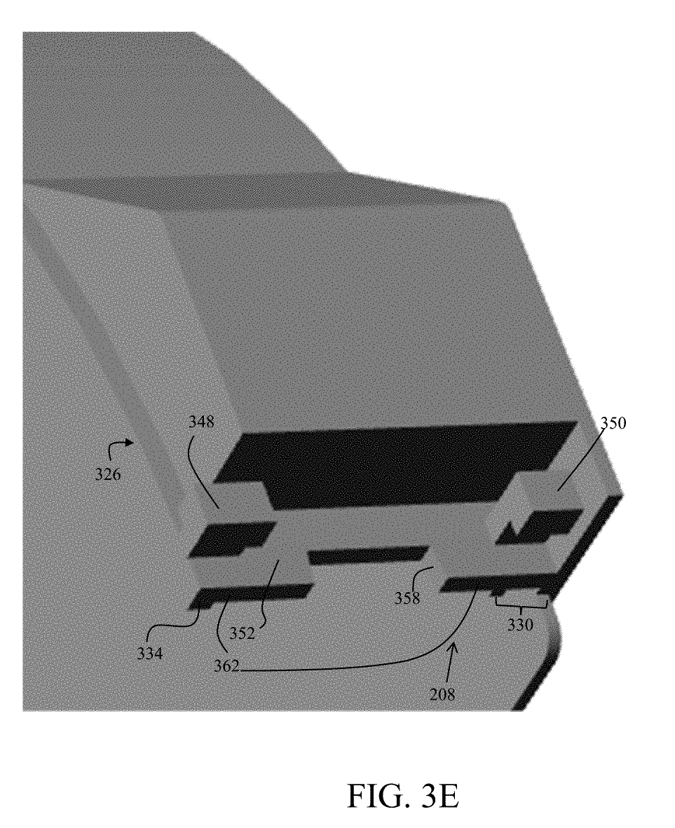

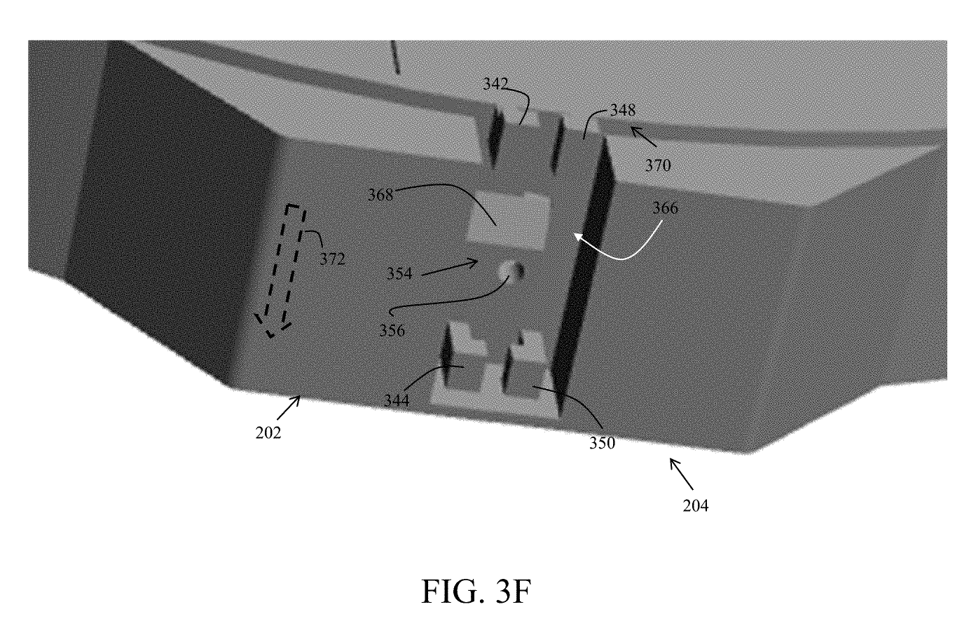

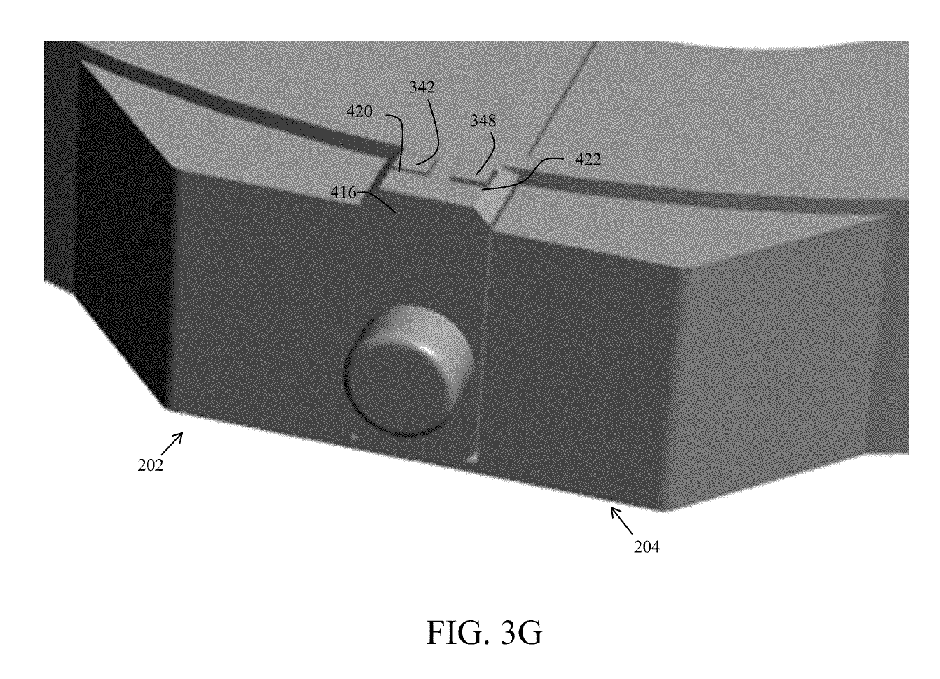

FIGS. 3A to 3G are non-limiting, exemplary illustrations of various views of the first and the second pieces of the member of the anti-theft device in accordance with one or more embodiments of the present invention. FIGS. 3A to 3B are non-limiting, exemplary illustrations of various views of the first piece whereas FIGS. 3C to 3E are non-limiting, exemplary illustrations of various views of the second piece. As illustrated in FIGS. 1 to 3G, first piece 212 includes a first coupling end 302 and second piece 214 includes a second coupling end 304, with first coupling end 302 movably associated with a second coupling end 304, with first coupling end 302 and second coupling end 304 coupled with a pin 308 (e.g., a hinge pin) to form a hinge mechanism 306.

First piece 212 includes a first base portion 310 and a first wall portion 312 generally vertically extending from a first outer periphery portion 314 of first base portion 310. First wall portion 312 includes a first engagement structure portion 318 near first base portion 310, and a second engagement structure portion 322 generally near or at top of first wall portion 312. In this non-limiting, exemplary instance, first engagement structure portion 318 may comprise of an interior facing side recess (e.g., a formed groove, channel, etc.) for receiving a first part of projection 112 of article 104 to thereby securely interlock article 104 with first piece 212. Further, in this non-limiting, exemplary instance second engagement structure portion 322 may comprise of an interior facing protuberance that engages part of the projection 112 of article 104 when article 104 is forcibly moved out of first engagement structure portion 318.

As further illustrated in FIGS. 1 to 3G, second piece 214 (FIG. 3C) includes a second base portion 324 and a second wall portion 326 generally vertically extending from a second outer periphery portion 336 of second base portion 324. Second wall portion 326 includes a third engagement structure portion 330 near second base portion 326 and a fourth engagement structure portion 334 at or near top of second wall portion 326. In this non-limiting, exemplary instance, third engagement structure portion 330 (identical to first engagement structure portion 318) may comprise of an interior facing side recess (e.g., a formed groove, channel, etc.) for receiving a part of projection 112 of article 104 to thereby securely interlock article 104 with second piece 214. Fourth engagement structure portion 334 is an interior facing protuberance that engages the projection from the article when the article is forcibly moved out of the third engagement structure portion 330. Further, in this non-limiting, exemplary instance fourth engagement structure portion 334 (identical to second engagement structure portion 322) may comprise of an interior facing protuberance that engages part of the projection 112 of article 104 when article 104 is forcibly moved out of third engagement structure portion 330.

Referring to both FIGS. 3A and 3D, first base portion 310 of first piece 212 and second base portion 324 of second piece 214 may comprise of respective complementary engagement structures 338 (FIG. 3A) and 340 (FIG. 3D). Complementary engagement structures 338 and 340 are comprised of a complementary combination of projections and recesses formed from complementary offset surfaces 338 and 340 on respective first and second base portions 310 and 324. When engaged, first base portion 310 of first piece 212 and second base portion 324 of second piece 214 define opening 320.

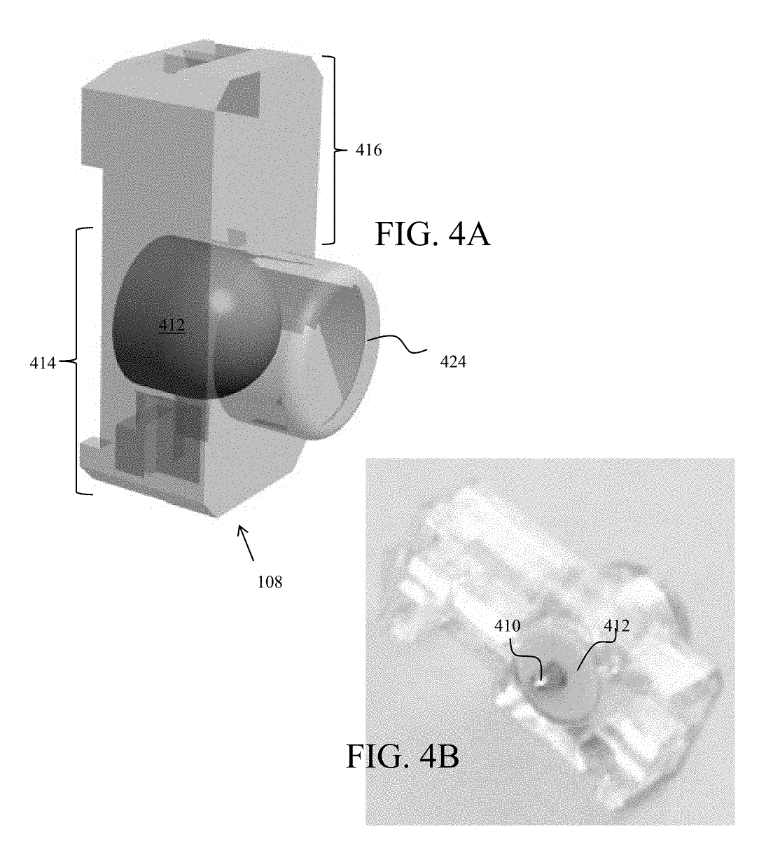

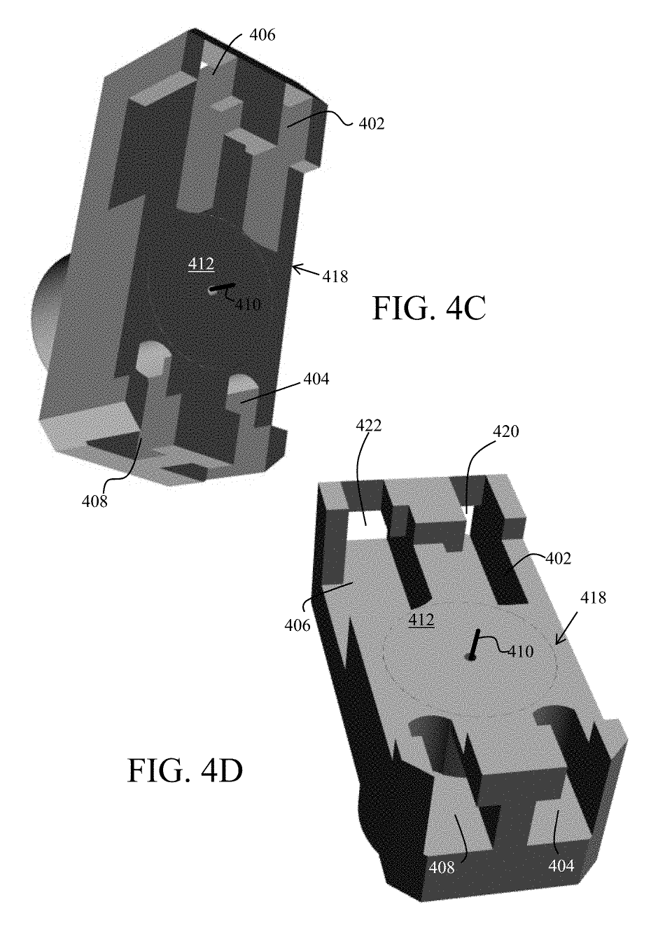

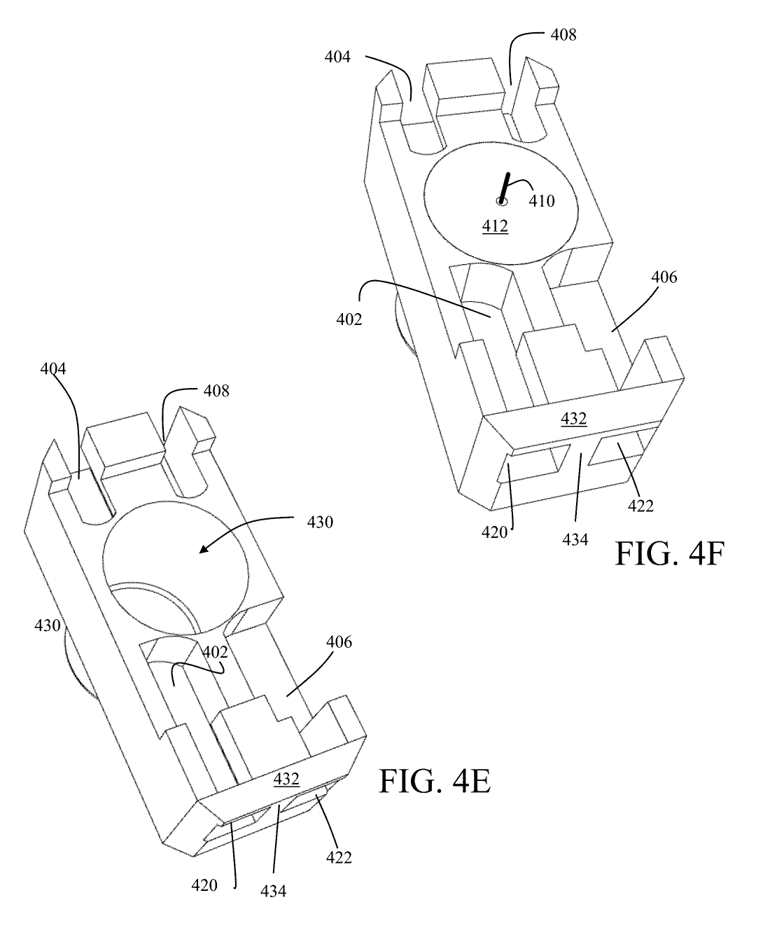

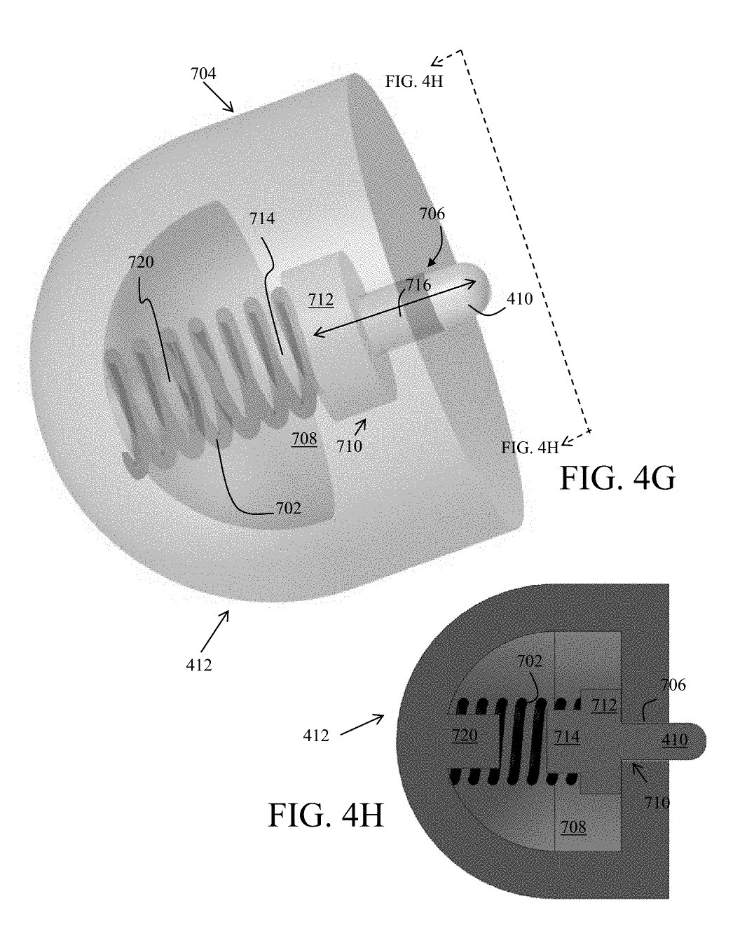

Referring to both FIGS. 3B and 3E, FIG. 3B is an enlarged perspective view of first free end 202 of first piece 212 of member 102, and FIG. 3E is enlarged perspective view of second free end 204 of second piece 214 of member 102. As indicated above, first free end 202 has first securing structure 206 (FIG. 3B) and second free end 204 has second securing structure 208 (FIG. 3E) that may interlock with interlocking mechanism 108 to securely and detachably maintain clasp onto article 104. Accordingly, first and second securing structures 206 and 208 include structure that is complementary to structure of interlocking mechanism 108. As a non-limiting example, in this non-limiting, exemplary instance, first securing structure 206 (FIG. 3B) may include an exemplary first upper interlock flange 342 and a first lower interlock flange 344 that protrude generally perpendicular an exterior facing side 346 of first wall portion 312, which are complementary to and engage with respective first upper recess or opening 402 (FIG. 4C) and first lower recess or opening 404 on interlocking mechanism 108. Second securing structure 208 (FIG. 3E) may include an exemplary second upper interlock flange 348 and a second lower interlock flange 350 that protrude generally perpendicular an exterior facing side 352 of second wall portion 326, which are complementary to and engage with respective second upper recess or opening 406 (FIG. 4C) and second lower recess or opening 408 on interlocking mechanism 108.

As best illustrated in FIG. 3B, further included with first securing structure 206 is a latch retainer 354 with a guide 368. Latch retainer (or “catch”) 354 extends substantially parallel first wall portion 312 and includes an opening 356 below guide 368 that receives an locking member (or pin) 410 (FIG. 4B) of a lock assembly 412 (FIGS. 4A to 4H).

As best illustrated in FIG. 3E, second securing structure 208 includes a recess 358, which is complementary to extended structure of lock retainer 354. Accordingly, when first and second ends 202 and 204 are moved along paths 326 and 328 to a closed position, extended structure of lock retainer 354 rests within recess 358 of second securing structure 208. A first lateral end 360 (FIG. 3B) of first end 202 contacts a second lateral end 362 (FIG. 3E) of second end 204, forming a cavity 366 (best illustrated in FIG. 3F) that accommodates and houses interlocking mechanism 108 (best illustrated in FIG. 3G). Therefore, interlock mechanism 108 mounts onto both first and second securing structures 206 and 208 to maintain them in closed position and further, the lock assembly 412 via locking member or pin 410 locks the first and second ends 202 and 204 together.

FIGS. 4A to 4H are non-limiting, exemplary illustrations of an exemplary interlocking mechanism in accordance with one or more embodiments of the present invention. As illustrated, interlocking mechanism 108 is configures to be positioned within cavity 366 and be mounted onto first and second securing structures 206 and 208.

Interlocking mechanism 108 is comprised of an upper portion 416 and a lower portion 414 that includes a lock chamber 430 that houses locking assembly 412, and includes various topographies at engagement side 418 that receive and interlock with complementary topographies (detailed above) of first and second securing structures 206 and 208. As illustrated, first and second upper openings 402 and 406 are elongated and further include window openings 420 and 422 divided by walls 432 and 434, with first and second lower recesses or openings 404 and 408 forming cavities.

To mount interlocking mechanism 108 onto first and second securing structures 206 and 208, first and second ends 202 and 204 of first and second pieces 212 and 214 are first moved along their respective paths 236 and 238 from an open position (FIG. 2B) to a closed position where first and second ends 202 and 204 contact as shown in FIG. 3F. Thereafter, interlocking mechanism 108 is held in upright position (with the upper portion 416 oriented as illustrated in FIG. 4A) and maneuvered into cavity 366, with engagement side 418 facing cavity 366.

When maneuvering interlocking mechanism 108 into cavity 366, upper portion 416 is generally oriented and set above (and outside) a top portion 370 of cavity 366. Thereafter, interlocking mechanism 108 is held in place with lower portion 414 flat against cavity 366 with locking member or pin 410 of lock assembly 412 in a fully extended position resting at top end of guide 368. At this position, first upper interlock flange 342 and second upper interlock flange 348 are already inserted into respective first upper recess 402 and second upper recess 406, but not in interlock position.

Sliding interlocking mechanism 108 in a downward direction (indicated by arrow 372) within the cavity 366 from the position described would allow first and second upper openings 402 and 406 to maneuver over first upper interlock flange 342 and second upper interlock flange 348 and into locking position, wherein the top ends of first upper interlock flange 342 and second upper interlock flange 348 extend out or rest within openings 420 and 422 of first and second upper recesses 402 and 406 (as best shown in FIG. 3F).

Further sliding of interlocking mechanism 108 in downward direction 372 within cavity 366 would also bring interlocking member or pin 410 of lock assembly 412 in contact against guide 368 of lock retainer 354 (which is sloped at an angle). Interlocking member or pin 410 biased by a resilient member 702 to a fully extended position, would progressively be compressed against a biasing force of a resilient member 702 to a contracted position as it passes over sloped guide 368 until interlocking member or pin 410 is positioned at top of opening 356. There, pin 410 is snapped back to the default, extended position by resilient member 702 and interlocked within opening 356. At the same time, first lower interlock flange 344 and second lower interlock flange 350 are also positioned inside and engage respective first and second lower opening 404 and 408 of interlocking mechanism 108.

A well-known magnetic detacher may be used to remove interlocking mechanism 108 from first and second securing structures 206 and 208. The magnetic detacher may be positioned on top of interlock assembly 412 (protuberance 424), where the force of the magnet of the magnetic detacher would extract interlocking member or pin 410 out of opening 356. Thereafter, the interlocking mechanism 108 is simply moved within cavity 366 in an upward direction (opposite direction 372) where it fully detaches and is removed from first and second securing structures 206 and 208.

FIG. 4G is a non-limiting, exemplary embodiment of a lock assembly 412 in accordance with one or more embodiments of the present invention, with FIG. 4H showing a sectional view. Lock assembly 412 is comprised of resilient member 702 that forces locking member or pin 410 of a locking probe 710 to lock within opening 356.

Resilient member 702 and locking probe 710 are accommodated within a cavity 708 of lock assembly chamber 704 (with a closed end 720), with locking member 410 extending from a hole 706 of the chamber 704. Resilient member 702 is formed of an elongated cylindrical shaped helical spring that biases locking probe 710 at portion 714 of engagement section 712 of locking probe 710 towards opening 356 along a linear reciprocating path 716. Accordingly, locking probe 710 includes locking member 410 that is biased to a protruded position by spring 702 (out from hole 706), contacts the beveled surface 368, is progressively forced to a partially retracted position, and is eventually released back to a fully protruded position and snapped into keeper 356 when interlocking mechanism 108 is moved to the fixed locking position, whereby locking member 410 of locking probe 710 interlocks with opening 356 such that insertion into opening 356 is allowed, but extraction is not (unless a magnetic detacher is used).

To disengage interlocking mechanism 108, locking probe 710 is retracted, released, and disengaged from the interlocked and engaged position within the opening 356 when the force exerted by resilient member 702 is reversed. That is, locking member 410 of locking probe 710 is released and disengaged from opening 356 when the force exerted by resilient member 702 is reversed, with the reversed force pulling locking probe 710 and hence, locking member 410 out and away from the opening 356, against spring 702. That is, to release article 104, interlock mechanism 108 is brought into physical contact with well-known suitable (in terms of magnetic strength, for example) magnetic detacher that enables the release and removal of locking member 410 from opening 356. The magnetic detacher magnetically pulls-in locking probe 710 in reciprocating path 716 against the push of resilient member 702 (compresses the illustrated spring 702) to thereby pull-in probe 710 and release locking member 410 from opening 356, unlocking first and second pieces 212 and 214.

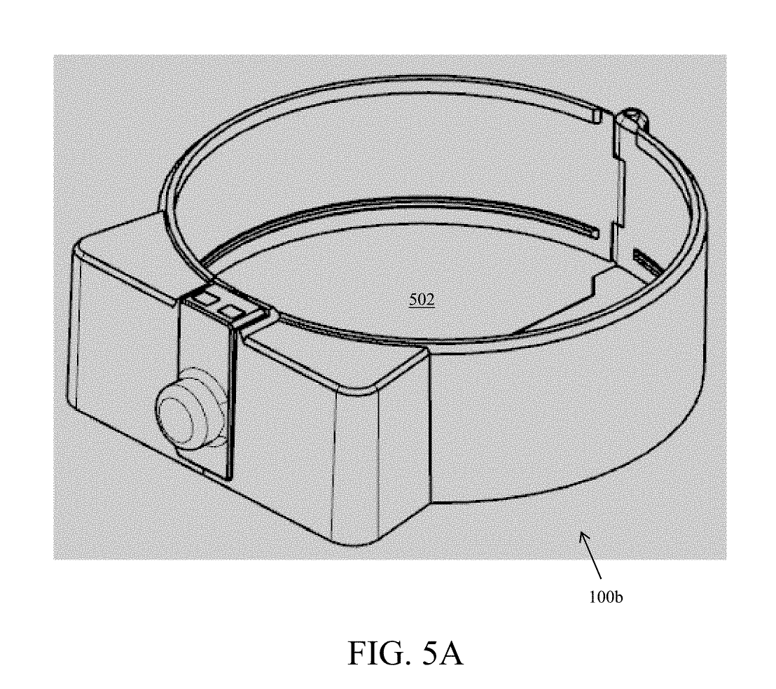

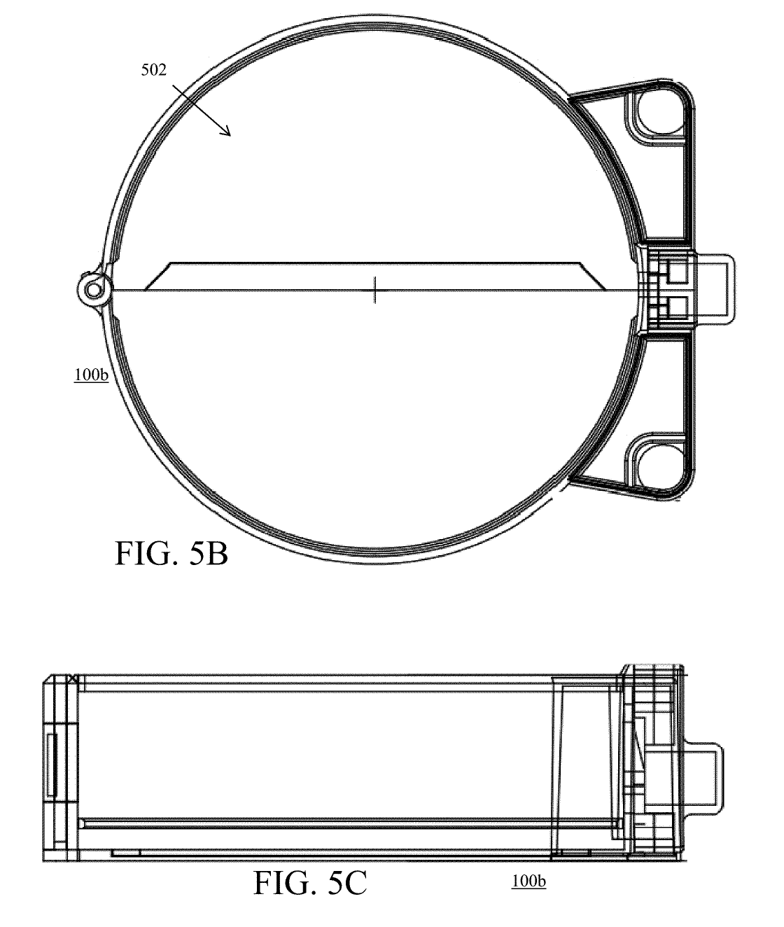

FIGS. 5A to 5C are non-limiting, exemplary illustrations of an anti-theft device in accordance with one or more embodiments of the present invention. Anti-theft device 100b illustrated in FIGS. 5A to 5C includes similar corresponding or equivalent components, interconnections, functional, operational, and or cooperative relationships as the device 100a that is shown in FIGS. 1A to 4H, and described above. Therefore, for the sake of brevity, clarity, convenience, and to avoid duplication, the general description of FIGS. 5A to 5C will not repeat every corresponding or equivalent component, interconnections, functional, operational, and or cooperative relationships that has already been described above in relation to anti-theft device 100a that is shown in FIGS. 1A to 4H. As illustrated, anti-theft device 100b is comprised of base 502 that when in closed position, has no opening 230.

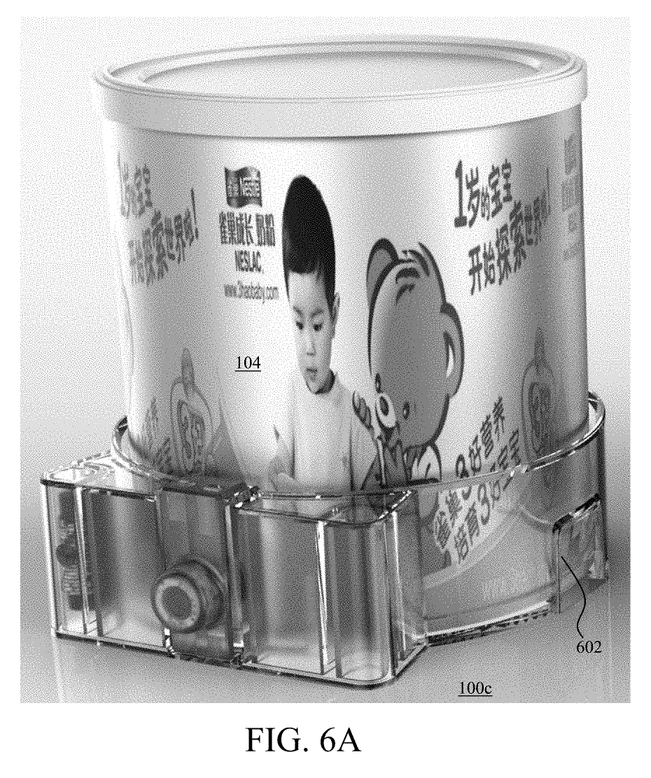

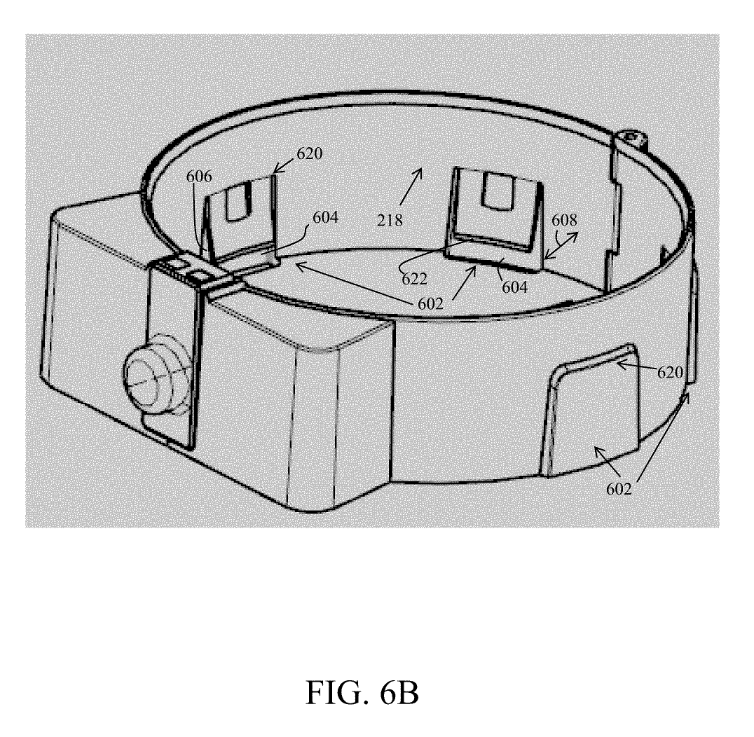

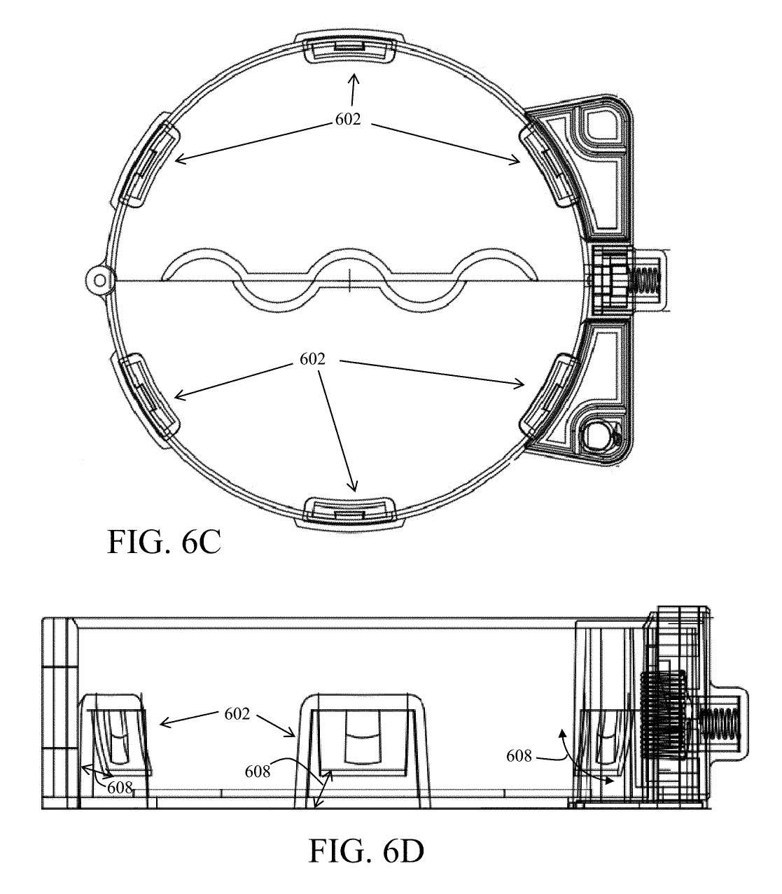

FIGS. 6A to 6D are non-limiting, exemplary illustrations of an anti-theft device in accordance with one or more embodiments of the present invention. Anti-theft device 100c illustrated in FIGS. 6A to 6D includes similar corresponding or equivalent components, interconnections, functional, operational, and or cooperative relationships as the devices 100a and 100b that are shown in FIGS. 1A to 5C, and described above. Therefore, for the sake of brevity, clarity, convenience, and to avoid duplication, the general description of FIGS. 6A to 6D will not repeat every corresponding or equivalent component, interconnections, functional, operational, and or cooperative relationships that has already been described above in relation to anti-theft devices 100a and 100b that are shown in FIGS. 1A to 5C.

As illustrated in FIGS. 6A to 6D, anti-theft device 100c is comprised of one or more first engagement structures 602 configured as a “clip” extending at an angle from wall 218 towards interior base 216 of anti-theft device 100c. First engagement structures 602 are cantilevered at a first end 620 from wall 218 at an angle and have a free second end 622. The configuration provides a space 606 behind first engagement structures 602 that enable them to flex and move in a reciprocating path 608 to frictionally engage article 104.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Further, the specification is not confined to the disclosed embodiments. Therefore, while exemplary illustrative embodiments of the invention have been described, numerous variations and alternative embodiments will occur to those skilled in the art. For example, one or more embodiments of the present invention may be associated with a top rather than the illustrated bottom of an article with similar infrastructure. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. An anti-theft device, comprising:
a member with a first free end and a second free end;
the first free end having a first securing structure;
the second free end having a second securing structure; and
an Electronic Article Surveillance (EAS) device that is associated with the member.

2. The anti-theft device as set forth in claim 1, wherein:
the member is adapted to engage with an article.

3. The anti-theft device as set forth in claim 1, wherein:
the member clasps onto an article.

4. The anti-theft device as set forth in claim 1, wherein:
the first securing structure and the second securing structure form complementary interlocking securing structures.

5. The anti-theft device as set forth in claim 4, wherein:
the complementary interlocking securing structures are interlocked by an interlocking mechanism.

6. The anti-theft device as set forth in claim 4, wherein:
the complementary interlocking securing structures are interlocked by an interlocking mechanism and unlocked by an unlocking mechanism.

7. The anti-theft device as set forth in claim 1, wherein:
the member includes:
a base;
a wall protruding from an outer periphery of the base.

8. The anti-theft device as set forth in claim 7, wherein:
the wall at a first end, proximal to the base includes a first engagement structure, and at a second end, distal from the base includes a second engagement structure.

9. The anti-theft device as set forth in claim 8, wherein:
the first engagement structure is comprised of an interior facing side channel for receiving a projection from an article to thereby securely interlock the article with the member; and
the second engagement structure is a protuberance that engages the projection from the article when the article is forcibly moved out of the first engagement structure.

10. The anti-theft device as set forth in claim 1, wherein:
the base has a surface that engages with and supports a portion of the article.

11. The anti-theft device as set forth in claim 1, wherein:
the member is transparent and generally rigid.

12. The anti-theft device as set forth in claim 1, wherein:
the member encloses to contain and protect an article.

13. The anti-theft device as set forth in claim 1, wherein:
the member is a locking annular ring that surrounds an article.

14. The anti-theft device as set forth in claim 1, wherein:
the member is a polygonal locking ring that surrounds an article.

15. The anti-theft device as set forth in claim 7, wherein:
the base has an opening defined by an inner periphery of the base.

16. The anti-theft device as set forth in claim 7, wherein:
the wall at a first end, proximal to the base includes one or more engagement structures, forming a clip.

17. The anti-theft device as set forth in claim 1, wherein:
the member is comprised of a first piece and a second piece.

18. The anti-theft device as set forth in claim 1, wherein:
the member is comprised of a first piece that is movably associated with a second piece.

19. The anti-theft device as set forth in claim 18, wherein:
the first piece includes a first coupling end;
the second piece includes a second coupling end;
with the first coupling end movably associated with a second coupling end.

20. The anti-theft device as set forth in claim 19, wherein:
the first coupling end and the second coupling end form a hinge mechanism.

21. The anti-theft device as set forth in claim 18, wherein:
the first piece includes:
a first base;
a first wall protruding from a first outer periphery of the first base.

22. The anti-theft device as set forth in claim 19, wherein:
the first wall at a first end, proximal to the first base includes a first engagement structure, and at a second end, distal from the first base includes a second engagement structure.

23. The anti-theft device as set forth in claim 20, wherein:
the first engagement structure is comprised of a recess for receiving a projection from an article to thereby securely interlock the article with the first piece; and
the second engagement structure is a protuberance that engages the projection from the article when the article is forcibly moved out of the first engagement structure.

24. The anti-theft device as set forth in claim 15, wherein:
the second piece includes:
a second base;
a second wall protruding from a second outer periphery of the second base.

25. The anti-theft device as set forth in claim 22, wherein:
the second wall at a first end, proximal to the second base includes a first engagement structure, and at a second end, distal from the second base includes a second engagement structure.

26. The anti-theft device as set forth in claim 23, wherein:
the first engagement structure is comprised of a recess for receiving a projection from an article to thereby securely interlock the article with the second piece; and
the second engagement structure is a protuberance that engages the projection from the article when the article is forcibly moved out of the first engagement structure.

27. The anti-theft device as set forth in claim 15, wherein:
the first piece and the second piece include:
a base;
a wall protruding from an outer periphery of the base.

28. The anti-theft device as set forth in claim 25, wherein:
the base of the first and the second piece include complementary engagement structures that when engaged, the base of the first and the second piece define the opening of the base.

29. The anti-theft device as set forth in claim 26 wherein:
the complementary engagement structures are comprised of a complementary combination of projections and recesses at generally opposite ends of the base of the first piece and the second piece.

30. The anti-theft device as set forth in claim 27, wherein:
an opening is defined by an inner periphery of the base.

31. The anti-theft device as set forth in claim 5, wherein:
the interlocking mechanism is comprised of a first recess that engages a first projection of the first securing structure, and a second recess that engages a second projection of the second securing structure.

32. The anti-theft device as set forth in claim 1, wherein:
one of the first and second securing structure includes a projection with an opening that receives an engagement pin of a lock assembly to thereby interlock the mounted interlocking mechanism with the first and second securing structures.

33. A theft-deterrent device, comprising:
a annular member with a first free end and a second free end;
the first free end having a first securing structure;
the second free end having a second securing structure;
first free end and the second free end interlock through first securing structure and second securing structure by an interlock mechanism; and
an Electronic Article Surveillance (EAS) device that is associated with the annular member.

34. A theft-deterrent device, comprising:
a member comprised of a first piece with a first free end and a second piece with a second free end;
the first free end having a first securing structure;
the second free end having a second securing structure;
first free end and the second free end interlock through first securing structure and second securing structure by an interlock mechanism; and
an Electronic Article Surveillance (EAS) device that is associated with at least one of the first or second piece.
